(19) United States
(12) Patent Application Publication
(10) Pub. No.: US 2008/0229742 A1
(43) Pub. Date: Sep. 25, 2008

(54) Extended Leading-Edge Compressor Wheel

(76) Inventors: Philippe Renaud, Sanchey (FR); Thomas Dubois, Nancy (FR); Hua Chen, Blackburn (GB)

Correspondence Address: HONEYWELL TURBO TECHNOLOGIES, 23326 HAWTHORNE BOULEVARD, SUITE #200, TORRANCE, CA, 90505, US

(21) Appl. No.: 11/689,339

(22) Filed: Mar. 21, 2007

(51) Int. Cl. F02G 5/00; F01D 5/00

(52) U.S. Cl. 60/597; 416/223 R

(57) ABSTRACT

A turbocharger system having a compressor housing containing a rotating compressor wheel with a plurality of main blades that define an impeller passageway from an inducer to an exducer. Each main blade has a leading edge characterized by an extension forming a non-planar, conical inducer leading edge, and a trailing edge characterized by a reverse-clip-extension forming a non-cylindrical, conical exducer trailing edge.

The present invention relates generally to compressors for turbomachinery and, more particularly, to apparatus and methods of improving compressor performance.

### BACKGROUND OF THE INVENTION

In turbocharger technology a rotating compressor wheel within a compressor housing sucks air through an intake duct, compresses it in an impeller passage, and diffuses it into a compressor housing. The compressed air is supplied to an intake manifold of an internal combustion engine. The operating range of a compressor extends from a surge condition (wherein the airflow is “surging”), occurring at low airflow rates, to a choke condition (wherein the airflow is “choked”) experienced at high airflow rates. Surging airflow occurs when a compressor operates at a relatively low flow rate with respect to the compressor pressure ratio, and the resulting flow of air throughout the compressor becomes unstable. “Choking” occurs when a compressor tries to operate at a high flow rate that exceeds the mass flow rate available through the limited area of an intake end of the compressor wheel (known as the inducer) through which air arrives at the compressor wheel.

In the design of turbocharger impellers, a significant trade-off occurs between the need for a desired pressure ratio, the need for a wide flow range, the need for high compressor efficiencies, the dynamic stability of the impellers, and the acoustic considerations. For turbocharged-engine applications there is a speed limit for compressor impellers due to mechanical stresses, low cycle fatigue, high cycle fatigue and vibration issues. Moreover, in order to achieve desired pressure ratios, only a limited backward curvature can be used for the impeller given a life requirement and a performance target.

As a result of dynamic problems, it is known that clipping the leading edge of a blade (i.e., trimming back the blade on its shroud-side) raises the natural frequencies of blade modes of vibration involving a bending movement of the free end of the leading edge and reduces the mechanical stress at the blade root of the leading edge. It is also known to have a reverse clip on the leading edge of a splitter blade (i.e., small, partial blades between the main blades of an impeller, having leading edges downstream from the main blade leading edges).

Accordingly, there has existed a need for an apparatus and related methods to improve the operating characteristics of a compressor. Moreover, it is preferable that such apparatus are cost and weight efficient. Preferred embodiments of the present invention satisfy these and other needs, and provide further related advantages.

### SUMMARY OF THE INVENTION

In various embodiments, the present invention solves some or all of the needs mentioned above, typically providing a turbocharged engine, a turbocharger system, and/or a turbocharger compressor with optimized pressure ratios, extended flow range, improved efficiency and/or reduced tip speeds as compared with similar prior art turbocharger systems.

The turbocharger is provided with a centrifugal compressor wheel configured for rotation within a compressor housing along an axis of rotation.

The housing defines a shroud wall that forms an inlet leading into the compressor wheel. The compressor wheel includes a hub defining a hub wall connected to a hub edge of a plurality of blades (including main blades, and possibly including splitter blades). Each main blade defines a leading edge at an inlet end of the main blade, the leading edge extending from a hub-side at the hub edge to a shroud-side. Advantageously, the leading edge establishes an upstream-extension at an angle providing a longer flow path along the main blade, particularly at main blade locations distant from the hub wall (e.g., on the shroud side), and thereby, providing an increased energy transfer and pressure ratio over a similar main blade having a shorter flow path along its shroud side.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is a system layout of an internal combustion engine with a turbocharger and a charge air cooler embodying the present invention.

FIG. 2 is a front view of a compressor wheel, as used in the turbocharger of FIG. 1, including main blades and splitter blades.

FIG. 3 is a right side cross-section view of the compressor wheel depicted in FIG. 2.

FIG. 4 is a left side cross-section view of a compressor stage, as is used in the turbocharger of FIG. 1, with its main blades projected onto the plane of the page in a full meridional view.

FIG. 5 is a top half meridional view of the main blade depicted in FIG. 4, with airflow patterns depicted across the main blade.

FIG. 6 is a top half meridional view of a second embodiment of a main blade.

FIG. 7 is a top half meridional view of a third embodiment of a main blade.

FIG. 8 is a top half meridional view of a fourth embodiment of a main blade.

FIG. 9 is a top half meridional view of a fifth embodiment of a main blade.

FIG. 10 is a top half meridional view of a sixth embodiment of a main blade.

FIG. 11 is a top half meridional view of a seventh embodiment of a main blade.

FIG. 12 is a top half meridional view of a eighth embodiment of a main blade.

FIG. 13 is a top half meridional view of a ninth embodiment of a main blade.

FIG. 14 is a top half meridional view of a tenth embodiment of a main blade, being similar to the blade depicted in FIG. 5, but with features accentuated to better illuminate properties of the embodiment.

FIG. 15 is a top half meridional view of a eleventh embodiment of a main blade.

FIG. 16 is a combined graph of analytical data from CFD (Computational Fluid Dynamics) analysis showing the increased flow range and efficiency provided by main blades having a reverse-clip-extension at an inducer.

### DETAILED DESCRIPTION OF THE PREFERRED EMBODIMENTS

The invention summarized above and defined by the enumerated claims may be better understood by referring to the following detailed and description, which should be read with the accompanying drawings. This detailed description of particular preferred embodiments of the invention, set out below to enable one to build and use particular implementations of the invention, is not intended to limit the enumerated claims, but rather, it is intended to provide particular examples of them.

Typical embodiments of the present invention reside in a compressor wheel for a turbocharger, along with associated methods and apparatus (e.g., compressors, turbochargers and turbocharged internal combustion engines). Preferred embodiments of the invention are assemblies that provide for improved pressure ratios and/or related flow characteristics through the use of main blades (i.e., full compressor blades, as opposed to partial, splitter blades that extend downstream from a splitter blade leading edge intermediate the positions of the full blade leading and trailing edges) characterized by an upstream-extended leading edge, and possibly a reverse-clipped leading edge.

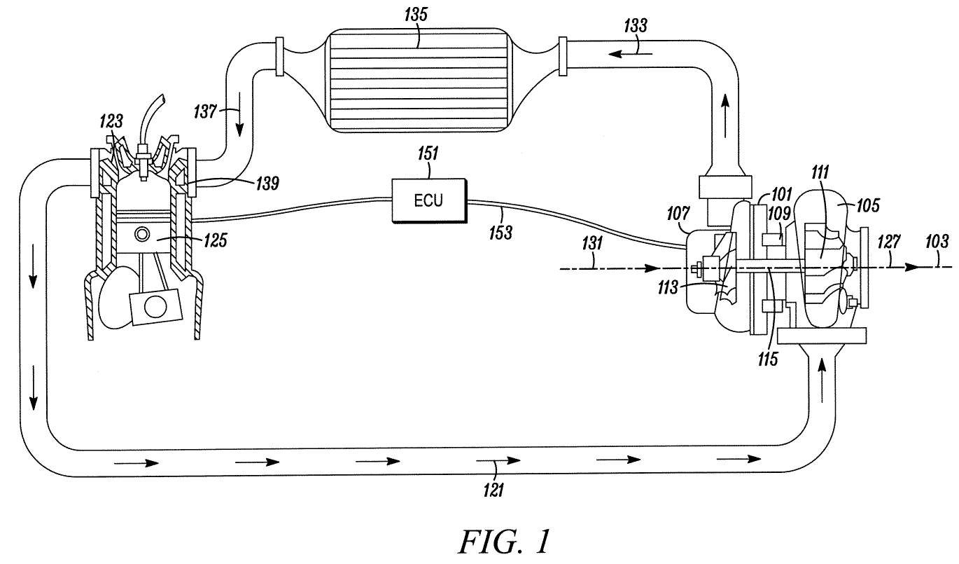

With reference to FIG. 1, in a first embodiment of the invention, a turbocharger 101 includes a turbocharger housing and a rotor configured to rotate within the turbocharger housing along an axis of rotor rotation 103 on thrust bearings and journal bearings (or alternatively, other bearings such as ball bearings). The turbocharger housing includes a turbine housing 105, a compressor housing 107, and a bearing housing 109 (i.e., center housing) that connects the turbine housing to the compressor housing. The rotor includes a turbine wheel 111 located substantially within the turbine housing, a compressor wheel 113 located substantially within the compressor housing, and a shaft 115 extending along the axis of rotor rotation, through the bearing housing, to connect the turbine wheel to the compressor wheel.

The turbine housing 105 and turbine wheel 111 form a turbine configured to circumferentially receive a high-pressure and high-temperature exhaust gas stream 121 from an engine, e.g., from an exhaust manifold 123 of an internal combustion engine 125. The turbine wheel (and thus the rotor) is driven in rotation around the axis of rotor rotation 103 by the high-pressure and high-temperature exhaust gas stream, which becomes a lower-pressure and lower-temperature exhaust gas stream 127 and is axially released into an exhaust system (not shown).

The compressor housing 107 and compressor wheel 113 form a compressor stage. The compressor wheel, being driven in rotation by the exhaust-gas driven turbine wheel 111, is configured to compress axially received input air (e.g., ambient air 131, or already-pressurized air from a previous-stage in a multi-stage compressor) into a pressurized air stream 133 that is ejected circumferentially from the compressor. Due to the compression process, the pressurized air stream is characterized by an increased temperature, over that of the input air. Optionally, the pressurized air stream may be channeled through a convectively cooled charge air cooler 135 configured to dissipate heat from the pressurized air stream, increasing its density. The resulting cooled and pressurized output air stream 137 is channeled into an intake manifold 139 on the internal combustion engine, or alternatively, into a subsequent-stage, in-series compressor. The operation of the system is controlled by an ECU 151 (electronic control unit) that connects to the remainder of the system via communication connections 153.

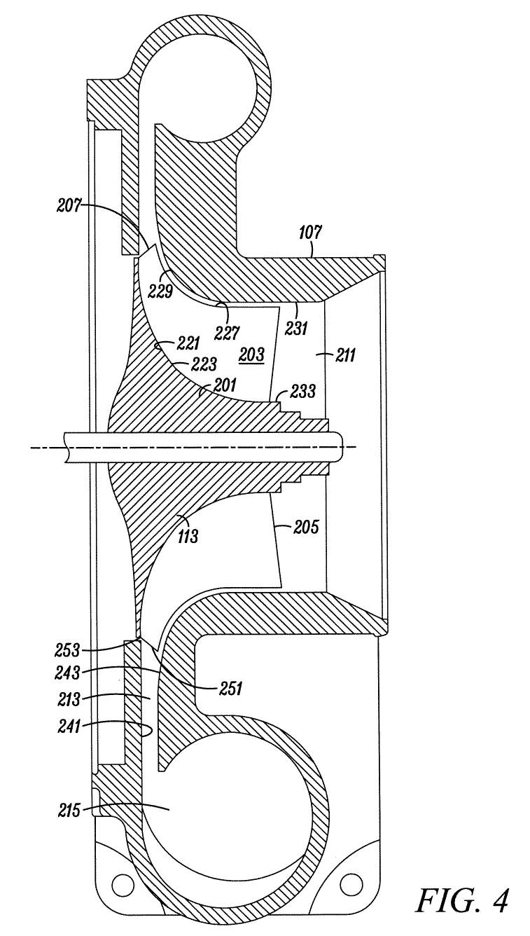

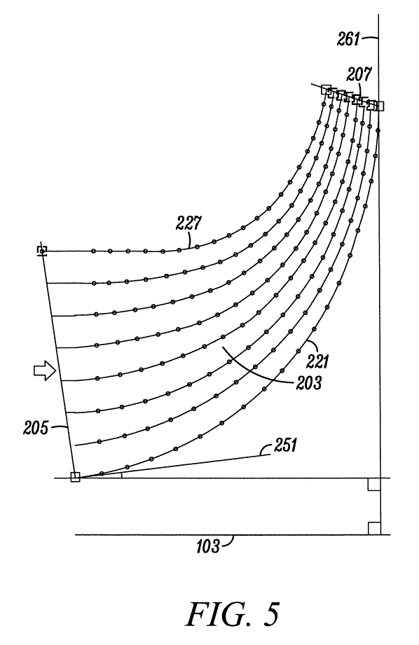

With reference to FIGS. 1 through 4, the compressor wheel 113 is a radial compressor wheel that includes a hub 201 and a plurality of blades, including a plurality of main blades 203 and a plurality of splitter blades 204. The blades preferably have a backward curvature (i.e., a back swept angle wherein the wheel exit blade angle is backward swept circumferentially relative to a radial line and the leading edges of the blades lead the trailing edges of the blades when the hub is rotated to compress air) rather than being configured to extend in a purely radial blade configuration. Because the blades have backward curvature, a typical view of an impeller might not accurately depict the radius of the blade at several different radial locations on the blade. Such radii may be more accurately depicted using a meridional view—a rotational projection of a blade onto a plane containing the hub axis of rotation (e.g., a rotational projection of a side view of a blade on to the plane of the view). FIGS. 4-15 depict the main blades in such a projection, with FIGS. 5-15 showing only a top half (the bottom half being a symmetric mirror image of the top half).

Each main blade 203 has a leading edge 205 that defines the beginning of an inducer (i.e., an intake area for the combined set of main blades, extending through the circular paths of roughly the upstream ⅓ of the main blades), and a trailing edge 207 that defines the end of an exducer (i.e., a typically annular output area for the combined set of main blades, extending through the circular paths of roughly the downstream ⅓ of the main blades). Alternative embodiments may include compressor wheels without splitter blades (i.e., with main blades only).

The compressor housing 107 and compressor wheel 113 form a compression-air passageway, serially including an intake duct 211 leading axially into the inducer, an impeller passage leading from the inducer through the exducer and substantially conforming to the space through which the main blades rotate, a diffuser 213 leading radially outward from the exducer, and a volute 215 extending around the diffuser. The volute forms a scroll shape, and leads to an outlet port through which the pressurized air stream is ejected circumferentially (i.e., normal to the radius of the scroll at the exit) as the pressurized air stream 133 that passes to the (optional) charge air cooler and intake manifold. As is typical in automotive applications for a single stage turbo charging system, the intake duct is fed a stream of filtered external air from an intake passage in fluid communication with the external atmosphere. Each portion of the compression-air passageway is serially in fluid communication with the next. Alternative embodiments may include other types of turbo charging systems, such as two-stage turbochargers configured such that the air compressed by a first stage is used as the intake air of a second stage.

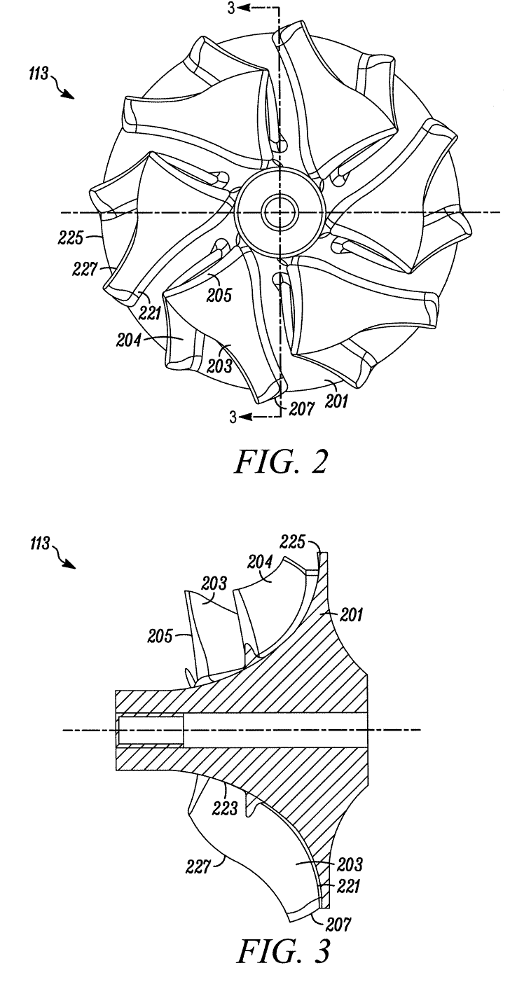

A hub edge 221 of each main blade 203 connects to the hub 201 on a hub wall 223 that extends along one side of an impeller passage from the upstream edge of the inducer to the outermost portion 225 of the hub that delimits the compression air passageway, which typically is substantially at the outer radial limit of the hub edge of the main blade (i.e., the hub edge of the main blade extends substantially to an outer radial limit of the hub wall). The hub edge of each main blade defines a three-dimensional curve along which the main blade connects to the hub at the hub wall. This may be curved both because of the axial-to-radial curvature of the hub wall (as depicted in FIG. 4) and because of the backward curvature of the main blades (as depicted in FIG. 2). Opposite the hub edge of each main blade is a shroud edge 227, which also forms a curve, and which substantially conforms to a shroud wall 229 of the compressor housing 107.

The intake duct 211 of this embodiment defines a cylindrical shroud-side inlet wall portion 231 extending axially to the inducer, the shroud-side inlet wall portion being integral with, the extension of, and smoothly transitioned to (i.e., extending at the same axial-to-radial angle and aligned with) the shroud wall 229 at the upstream end of the impeller passage. In some embodiments the hub wall 223 may be configured such that the hub-side of the impeller passageway at the upstream end of the impeller passageway is substantially cylindrical, and parallel to the wheel axis of rotation, but in the other embodiments it may be at least slightly angled from the axis of rotation. The hub 201 defines a hub-side inlet wall portion 233 extending to the inducer, the hub-side inlet wall portion being integral with, the extension of, and smoothly transitioning to the hub wall 223.

The diffuser 213 defines a hub-side diffuser wall portion 241 (that might or might not be planar and normal to the axis of rotation 103) around the outer radial limit of the hub wall, and a shroud-side diffuser wall portion 243 that is integral with, and the extension of, the shroud wall 229 through the diffuser. The hub 201 is configured such that the hub-side of the impeller passageway at the outer radial limit of the hub wall is smoothly transitioned to (i.e., extending at the same axial-to-radial angle, and aligned with) the hub-side diffuser wall portion (which also might or might not be planar and normal to the axis of rotation). Likewise, the shroud-side diffuser wall portion smoothly transitions from (i.e., it extends at the same axial-to-radial angle and is aligned with) the shroud wall. Embodiments may have various configurations, e.g., wherein the hub-side of the impeller passageway at the outer radial limit of the hub wall is or is not planar, and is or is not substantially normal to the wheel axis of rotation

FIG. 5 depicts airflow patterns across the meridionally viewed main blade 203. With reference to FIGS. 4 and 5 (and referring to all features in their projected state, as depicted), it may be seen that the intake duct 211 leads into the impeller passage via the inducer (i.e., past the leading edge 205). The shroud edge 227 and the hub edge 221 of the main blade extend from a shroud-side and hub-side (respectively) of the leading edge 205 to a shroud-side and hub-side (respectively) of the trailing edge 207.

At the leading edge 205, the hub edge 221 forms (i.e., becomes tangent to) a leading-edge-hub-line 251, which might be, but is typically not, parallel to the axis of rotation 103 (as depicted in FIG. 5). At the trailing edge, the hub edge 221 forms (i.e., becomes tangent to) a trailing-edge-hub-line 261 that might (as depicted in FIG. 5) or might not be perpendicular to the axis of rotation 103. One embodiment having a trailing-edge-hub-line that is not normal to the axis of rotation 103 is a compressor wheel configured for a mix-flow compressor.

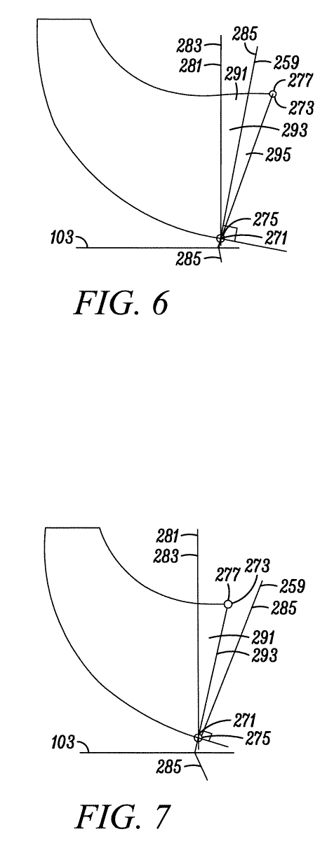

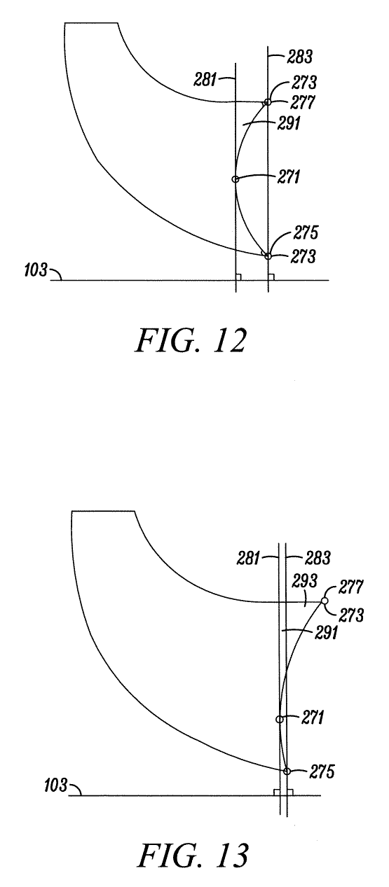

With reference to FIGS. 6-13 (depicting main blades of eight different embodiments), each main blade leading edge defines an (axially most) downstream-point 271, an (axially most) upstream-point 273, a hub-side-point 275 and a shroud-side-point 277. In some cases, there may be more than one downstream-point (or upstream-point) sharing the same axial location (e.g., see FIG. 12, having two upstream-points sharing the same axial location). In cases under the present invention wherein the (projected) leading edge forms a straight line, the upstream-point 273 will be the shroud-side-point 277, and the downstream-point 271 will be the hub-side-point 275.

A plurality of blade entry-planes are defined by the main blade (of each embodiment), each blade entry-plane being perpendicular to the axis of rotation 103. A downstream-entry-plane 281 is the plane perpendicular to the axis of rotation and passing through the leading-edge-downstream-point 271. Likewise, a hub-edge-entry-plane 283 is the plane perpendicular to the axis of rotation 103 and passing through the hub-side-point 275 on the leading edge. In some cases, such as cases under the present invention wherein the (projected) leading edge forms a straight line, the downstream-entry-plane 281 will be the hub-edge-entry-plane 283 (e.g., see FIGS. 6-10). In a meridional view, the entry-planes project as lines that are perpendicular to the axis of rotation 103.

In addition to the blade entry-planes, hubs characterized by leading-edge-hub-lines that are not parallel to their axes of rotation will each define a blade-entry-cone. More particularly, on both halves (top and bottom) of the meridional view (and symmetrically around the wheel), the hub defines a “normal-leading-edge-line” 259 that is perpendicular to the leading-edge-hub-line 251, that passes through the hub-side-point 275 of the leading edge, and that intersects the axis of rotation 103. In other words, a (each) normal-leading-edge-line is a line establishing where a (projected) straight leading edge would be if it were normal (i.e., perpendicular) to the leading-edge-hub-line 251 in its respective meridional view. The normal-leading-edge-line(s) 259, rotated around the axis of rotation 103, forms a blade-entry-cone 285. In the limiting case, wherein the leading-edge-hub-line 251 approaches being parallel to the axis of rotation 103, the blade-entry-cone 285 approaches the hub-edge-entry-plane 283.

Under one form of the invention, a compressor wheel is characterized by a reverse-clip-extension 295 (on all or some of the main blades) that extends substantially upstream of the blade-entry-cone 285. Embodiments under this form of the invention include those depicted in FIGS. 6, 8 and 9.

Under a second form of the invention, a compressor wheel is characterized by an upstream-extension 293 (on all or some of the main blades) that extends substantially upstream of the hub-edge-entry-plane 283. Embodiments under this form of the invention include those depicted in FIGS. 6-11 and 13.

Under a third form of the invention, a compressor wheel is characterized by an upstream-extension 291 (on all or some of the main blades) that extends substantially upstream of the downstream-entry-plane 291, wherein the upstream-extension is radially outward of the leading-edge-downstream-point on its respective blade. Embodiments under this form of the invention include those depicted in FIGS. 6-10 and 12-13.

In the context of this application, an extension is substantial if it is greater than manufacturing tolerances (e.g., large enough to affect compressor performance to a significant level, such as by 0.5 percent). Preferably, the extension affects the efficiency by 1 percent, and more preferably by 3 percent. For the purposes of this application, these comparisons are relative to a similar blade that lacks the portion of the extension upstream of the reference plane (or cone).

Turning to the individual embodiments depicted in FIGS. 6-13, it may be noted that the group of embodiments characterized by a reverse-clip-extension 295 are a subset of the group of embodiments characterized by a hub-edge-entry-plane upstream-extension 293, both being based on the hub-side-point 275. It also may be noted that neither the group of embodiments characterized by a hub-edge-entry-plane upstream-extension 293 nor the group of embodiments characterized by a downstream-entry-plane upstream-extension 291 are a subset of the other.

With reference to FIG. 6, an embodiment is disclosed that is characterized by a downstream-entry-plane upstream-extension 291, a hub-edge-entry-plane upstream-extension 293 and a reverse-clip-extension 295. The hub-edge-entry-plane upstream-extension 293 includes the reverse-clip-extension 295. Because the downstream-point 271 is the hub-side-point 275, the downstream-entry-plane upstream-extension 291 and the hub-edge-entry-plane upstream-extension 293 are identical.

With reference to FIG. 7, an embodiment similar to that of FIG. 6 is characterized by a downstream-entry-plane upstream-extension 291 and a hub-edge-entry-plane upstream-extension 293. No reverse-clip-extension 295 is upstream of the blade-entry-cone 285.

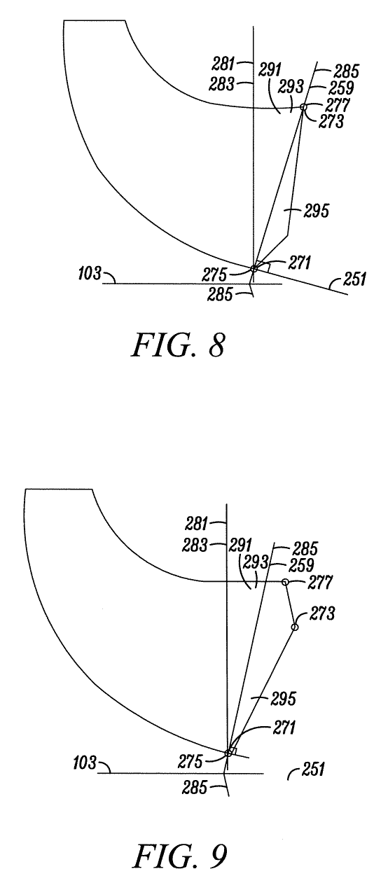

With reference to FIGS. 8 and 9, embodiments similar to that of FIG. 6 are characterized by a nonlinear leading edge, and have a downstream-entry-plane upstream-extension 291, a hub-edge-entry-plane upstream-extension 293 and a reverse-clip-extension 295. As was the case in the FIG. 6 embodiment, the hub-edge-entry-plane upstream-extension 293 includes the reverse-clip-extension 295, and the downstream-entry-plane upstream-extension 291 and the hub-edge-entry-plane upstream-extension 293 are identical.

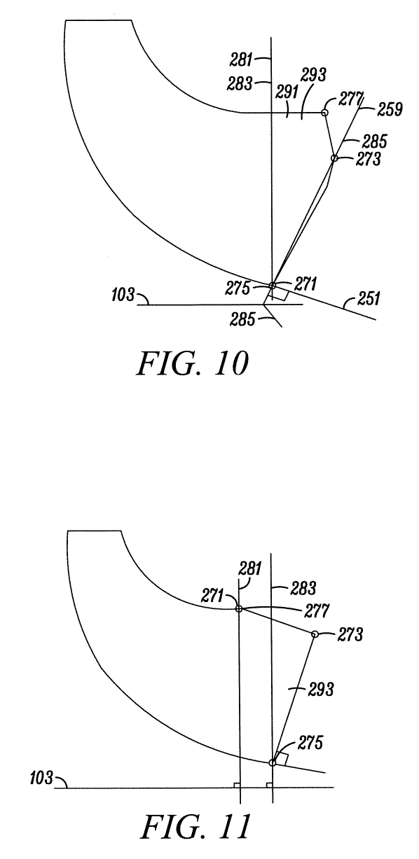

With reference to FIG. 10, another embodiment is also characterized by a nonlinear leading edge, and has a downstream-entry-plane upstream-extension 291 and a hub-edge-entry-plane upstream-extension 293. While this figure also appears to have a small reverse-clip-extension 295 upstream of the blade-entry-cone 285, it is not clear if the supposed reverse-clip-extension 295 extends substantially upstream of the blade-entry-cone (e.g., that it is large enough to affect compressor performance to a significant level as compared to a similar blade that lacks the extension upstream of the reference cone).

With reference to FIG. 11, an embodiment having a downstream-point 271 identical with its shroud-side-point 277 will inherently not have a downstream-entry-plane upstream-extension, as there can be no upstream-extension that is radially outward of the leading-edge-downstream-point. Nevertheless, this embodiment is characterized by a hub-edge-entry-plane upstream-extension 293 forward of its hub-edge-entry-plane 283. Variations of this embodiment could also be characterized by a reverse-clip-extension, though the depicted one is not.

With reference to FIG. 12, an embodiment is depicted that is characterized by a downstream-entry-plane upstream-extension 291, but no hub-edge-entry-plane upstream-extension or reverse-clip-extension. A variation of this embodiment, depicted in FIG. 13, includes both a downstream-entry-plane upstream-extension 291 and a hub-edge-entry-plane upstream-extension 293.

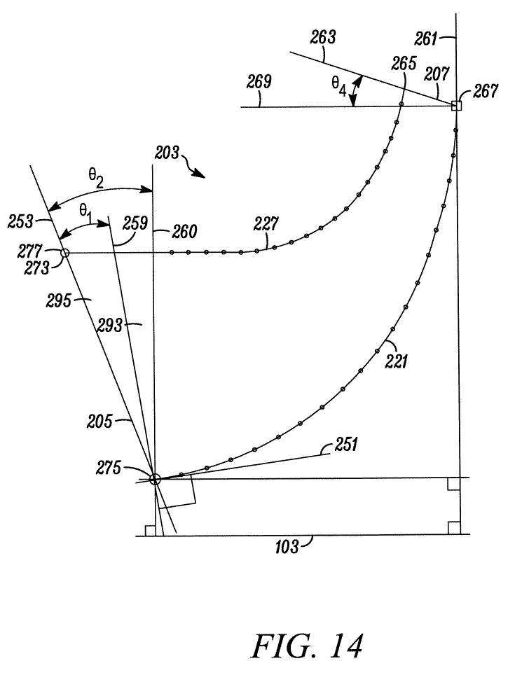

The above-described three forms of defining the invention (i.e., a downstream-entry-plane upstream-extension 291, a hub-edge-entry-plane upstream-extension 293 and a reverse-clip-extension 295) may be quantitatively characterized by angles referencing various points on the blades. With reference to FIG. 14, under the first form of the invention, the reverse-clip-extension 295 establishes a positive reverse-clip-angle Θ₁, which is defined for the purposes of this application as the angle between a blade-leading-edge-line 253 (i.e., a line defined by the leading edge of the blade) and the normal-leading-edge-line 259.

Because the leading edge is straight (i.e., linear) in this embodiment, the blade-leading-edge-line 253 may be defined by the hub-side-point 275 and shroud-edge point 277. If the leading edge is not straight, the blade-leading-edge-line 253 may be defined by the hub-edge point 275 and whichever point along the leading edge provides the greatest positive reverse-clip-angle Θ₁. In many cases, though not all, that point along the leading edge may be the upstream-point 273 (which is the shroud-side-point 277 in the depicted embodiment). The reverse-clip-angle Θ₁ is defined as positive for cases in which the leading edge 205 extends past (upstream from) the normal-leading-edge-line 259, which is the reverse of a design where a leading edge is clipped off for structural stability. Thus, for cases with a positive reverse-clip-angle Θ₁, the reverse-clip-angle Θ₁ is the smallest angle that can encompass the entire reverse-clip-extension 295, and has the hub-side-point 275 at its apex.

The leading edge 205 forms a non-planar (and perhaps substantially conical, as in the depicted embodiment) inducer inlet-boundary surface (i.e., the surface formed by the main blade leading edges as they are rotated around the axis of rotation). This inducer inlet-boundary surface is centrally concave, in that it forms a circular inner edge that is axially downstream of a concentric circular portion that is radially outward from the inner edge.

For a typical case wherein the leading-edge-hub-line 251 is angled from the axis of rotation 103 by 6 degrees, the leading edge 205 is preferably configured such that the reverse-clip-angle Θ₁ is positive and within the range of substantially 0 to 9 degrees. This range is believed to typically provide for an effective level of flow range and efficiency increase while maintaining dynamic stability. For impellers operating at very high speeds and/or having a high blade span, lower ranges might be desirable to avoid the need to use expensive, high-strength and/or low weight materials.

Under the second form of the invention, the leading edge forms the upstream-extension 293, establishing a positive hub-edge upstream-extension-angle Θ₂, which is defined for the purposes of this application as the angle between the blade-leading-edge-line 253 and a “radial-leading-edge-line” 260. For the purposes of this application, the radial-leading-edge-line 260 is understood to be a line establishing where a (projected) straight leading edge would be if it were radial (i.e., perpendicular to the axis of rotation 103) and passing through the hub-side-point 275. The radial-leading-edge-line 260 is the projection of the hub-edge-entry-plane 283 in a meridional view.

The upstream-extension-angle is defined as positive for cases in which the leading edge 205 extends upstream of the radial-leading-edge-line 263, which is the reverse of a design where a leading edge is clipped off. For cases with a positive upstream-extension-angle ⊖₂, the upstream-extension-angle Θ₂ is the smallest angle that encompasses the entire upstream-extension 293 under this form of the invention, and has hub-side-point 275 at its apex.

The leading edge 205 is preferably configured such that the upstream-extension-angle Θ₂ is positive and within the range of substantially 3 to 15 degrees. This range is believed to typically provide for an effective level of flow range and efficiency increase while maintaining dynamic stability. For impellers operating at very high speeds and/or having a high blade span, lower ranges might be desirable to avoid the need to use expensive, high-strength and/or low weight materials.

Based on best estimates, the range is believed to offer preferred tradeoffs between increased performance and issues of structural dynamics. In some cases it is anticipated that for structural stability the compressor wheel will be composed of a high-strength material, such as titanium, and/or possibly will have the blades characterized by a thickness that is greater than might otherwise be expected (though the latter is not typically expected to be practical). In other cases (such as in the lower-speed operation of a multi-stage turbocharger system), the anticipated operational parameters will more likely allow for other materials such as standard alloys to be used.

As previously discussed, the leading edge is extended to form a non-planar (and perhaps substantially conical, as depicted) inducer inlet-boundary surface (i.e., the surface formed by the main blade leading edges as they are rotated around the axis of rotation). This inducer inlet-boundary surface is centrally concave, in that forms a circular inner edge that is downstream of a concentric circular portion that is radially outward from the inner edge.

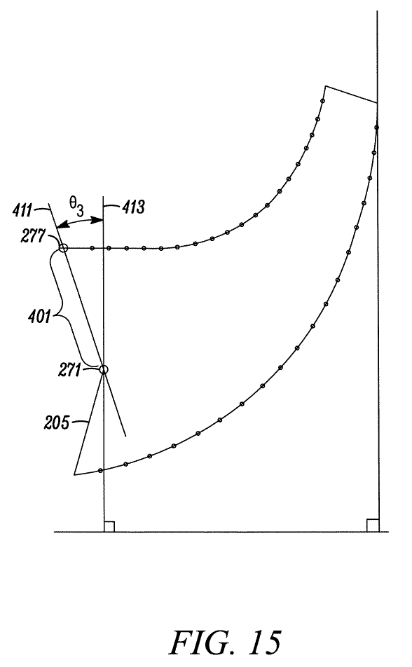

With reference to the embodiment depicted in FIG. 15 (which has similarities to the embodiment depicted in FIG. 12), under the third form of the invention, each main blade is configured such that its leading edge 205 has an outer-portion 401 that extends axially upstream, from the (axially most) downstream-point 271. Optionally, the most upstream part of the outer-portion may be the shroud-side-point 277. The downstream-point 271 establishes a downstream axial limit and an inner radial limit to the leading-edge-outer-portion 401. The shroud-edge upstream axial limit might (as depicted) or might not establish an upstream axial limit for the leading-edge-outer-portion 401.

In this form of the invention, the blade forms the upstream-extension 291 from its outer-portion 401. Similar to the way the hub-side-point 275 and the leading edge define the second form of the invention, the downstream-point 271 and the an outer-portion leading-edge-line 411 define this form of the invention, establishing a positive outer-portion upstream-extension-angle Θ₃.

Thus, the outer-portion upstream-extension-angle Θ₃ is defined for the purposes of this application as the angle between the outer-portion leading-edge-line 411 and a “outer-portion radial-leading-edge-line” 413. For the purposes of this application, the outer-portion radial-leading-edge-line 413 is understood to be a line establishing where a (projected) straight outer-portion leading edge would be if it were “perpendicular” to the axis of rotation 103 and passing through the downstream-point 271. The outer-portion radial-leading-edge-line 413 is the projection of the downstream-entry-plane 281 in a meridional view.

The outer-portion upstream-extension-angle Θ₃ is defined as positive for cases in which the outer-portion leading edge extends upstream of the outer-portion radial-leading-edge-line 413, which is the reverse of a design where a leading edge is clipped off. For cases with a positive outer-portion upstream-extension-angle Θ₃, the outer-portion upstream-extension-angle Θ₃ is the smallest angle that can encompass the entire outer-portion upstream-extension 293 under this form of the invention, and has downstream-point 271 at its apex.

The outer-portion leading edge is preferably configured such that the outer-portion upstream-extension-angle Θ₃ is positive and within the range of substantially 2 to 20 degrees. This range is believed to typically provide for an effective level of flow range and efficiency increase while maintaining dynamic stability. For impellers operating at very high speeds and/or having a high blade span, lower ranges might be desirable to avoid the need to use expensive, high-strength and/or low-weight materials.

As a result of having a positive outer-portion upstream-extension-angle Θ₃, the outer-portion leading edge of the of the blade extends to form a non-planar (and perhaps substantially conical) partial inducer inlet-boundary surface (i.e., the surface formed by the main blade partial leading edges as they are rotated around the axis of rotation). This partial inducer inlet-boundary surface is centrally concave, in that forms a circular inner edge that is downstream of a concentric circular portion that is radially outward from the inner edge.

With reference to FIG. 14, the trailing edge for any of the above-described forms of the invention may have a reverse-clip-extension that establishes a positive reverse-clip-angle Θ₄, which is defined for the purposes of this application as the angle between a blade-trailing-edge-line 263 (i.e., a line defined by the trailing edge) and a “normal-trailing-edge-line” 269. For the purposes of this application, a normal-trailing-edge-line is understood to be a line establishing where a (projected) trailing edge would be if it were “perpendicular” to the trailing-edge-hub-line 261). Because the trailing edge is linear in this embodiment, the blade-trailing-edge-line is defined by a shroud-edge outer radial limit point 265 and a hub-edge outer radial limit point 267. The reverse-clip-angle is defined as positive for cases in which the trailing edge extends downstream of the normal-trailing-edge-line 269, which is the reverse of a situation where a trailing edge is clipped off.

The trailing edge is configured such that the reverse-clip-angle Θ₄ is positive, and preferably is in the range of substantially 0 to substantially 40 degrees, which is believed will typically provide for an effective level of pressure increase while not usually leading to significant dynamic instability when combined with inducer main blade reverse-clipping. More preferably the reverse-clip-angle Θ₄ is in the range of substantially 10 to substantially 25 degrees. Based on best estimates, these ranges are believed to offer preferred tradeoffs between increased performance and issues of structural dynamics. For this embodiment, in which the trailing-edge-hub-line 261 forms a plane normal to the axis of rotation 103, this means that each impeller is configured such that its radius (i.e., its distance from the axis of rotation) at the shroud-edge outer radial limit 265 is larger than its radius at the hub-edge outer radial limit 267.

With reference again to FIG. 1, the embodiment further includes a controller, which may be included within the ECU 151, which connects to the turbocharger 101 via the communications connection 153. The turbine is configured to operate in conjunction with the controller to control turbine operation such that the compressor is driven in rotation through a variety of flow conditions, all of which provide for accelerated air leaving the wheel to reach only subsonic speeds. For the purposes of this application it is to be understood that the phrase ‘velocity of air leaving (or entering) the wheel (or the trailing edge of the main blade)’ refers to the absolute velocity (e.g., relative to the housing rather than to the wheel). In a first variation of the embodiment, the controller is configured to control turbine operation such that the compressor is driven in rotation through a variety of flow conditions, at least some of which provide for accelerated air leaving the wheel to reach supersonic speeds.

In a variation of various embodiments, the hub wall may extend beyond the outer radial limit of the hub edge. In another variation of the embodiment, the impeller could be configured as a mixed-flow impeller in which airflow from the trailing edge has both an axial and a radial component. In such a case, the trailing-edge-hub-line will not be normal to the axis of rotation. Nevertheless, the trailing edge may establish a positive reverse-clip-angle Θ₄ between the blade-trailing-edge-line and the normal-trailing-edge-line (which is where a trailing edge would be if it were “normal” to the trailing-edge-hub-line).

As compared to a compressor having main blades that lack the extension feature at an inducer (i.e., main blades having extension angles that are less than or equal to zero), a main blade under the invention will typically provide an increase in flow range and efficiency while maintaining the surge flow characteristics and without having a significant detriment to the structural dynamic stability of the impeller (e.g., from main blade modes of vibration characterized by significant motion of the reverse-clip-extension).

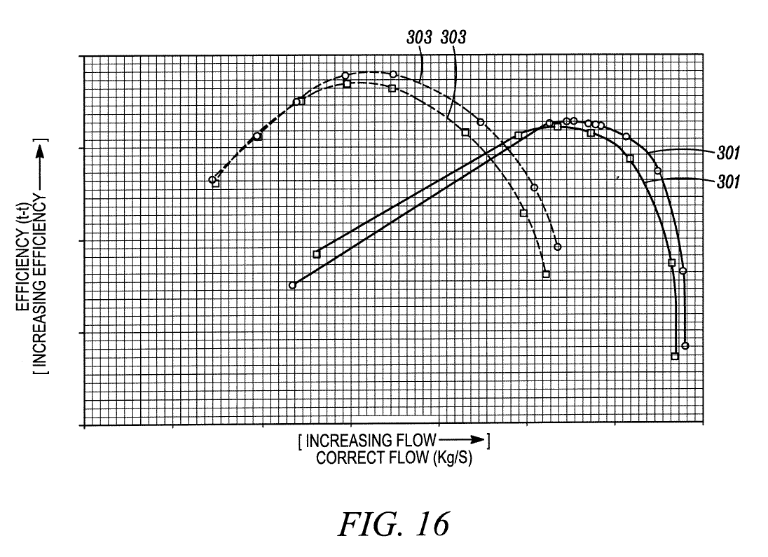

FIG. 16 depicts analytical cases that were simulated both with extended main blades and without. Throughout a substantial range of flow rates, the extended (leading edge) main blade analytical data 301 (i.e., analytical data from the main blades characterized by leading edges having a positive extension angle) provided a substantial increase in flow range and efficiency as compared to the analytical data 303 from the main blades lacking the extension feature. This data is shown at two different speeds of compressor rotation.

Additional embodiments may be configured to provide desired performance for specialized turbocharger configurations. For example, an embodiment of the invention might preferably be used as the high pressure stage of a series-sequential turbocharger compressor.

Alternatively, using the improved performance and known design techniques, compressors can be designed to operate at higher efficiencies and/or wider flow ranges.

It is to be understood that the invention further comprises related apparatus and methods for designing turbocharger systems and for producing turbocharger systems, as well as the apparatus and methods of the turbocharger systems themselves. In short, the above disclosed features can be combined in a wide variety of configurations within the anticipated scope of the invention.

While particular forms of the invention have been illustrated and described, it will be apparent that various modifications can be made without departing from the spirit and scope of the invention. For example, the trailing edges could be characterized by outer-portions having a positive outer-portion reverse-clip-angle. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claims.

What is claimed is:

1. A compressor wheel, comprising:
a compressor hub defining a hub wall and an axis of rotation; and
a plurality of compressor main blades connected to the hub wall, each main blade defining a hub edge along which the main blade connects to the hub wall, and each main blade defining a leading edge at an inlet end of the main blade, the leading edge extending from a hub-side-point at the hub edge;
wherein the main blades extend substantially upstream of a blade entry-plane perpendicular to the axis of rotation and passing through the hub-side-point.

2. The compressor wheel of claim 1, wherein the leading edge establishes a positive upstream-extension-angle of at least 3 degrees.

3. The compressor wheel of claim 1, wherein the leading edge establishes a positive upstream-extension-angle of between 3 and 15 degrees.

4. The compressor wheel of claim 1, wherein:
the hub is characterized by a leading-edge-hub-line that is not parallel to the axis of rotation; and
the main blades extend substantially upstream of a blade-entry-cone defined by lines that are perpendicular to the leading-edge-hub-line, that pass through the hub-side-point of the leading edge, and that intersect the axis of rotation.

5. The compressor wheel of claim 4, wherein the leading edge establishes a positive reverse-clip-angle of at least 3 degrees.

6. The compressor wheel of claim 4, wherein the leading edge establishes a positive reverse-clip-angle of between 0 and 9 degrees.

7. The compressor wheel of claim 1, wherein the trailing edge establishes a positive reverse-clip-angle.

8. The compressor wheel of claim 7, wherein the reverse-clip-angle is less than or equal to 40 degrees.

9. The compressor wheel of claim 1, wherein each hub edge extends along a three-dimensional curve along the hub wall.

10. The compressor wheel of claim 1, wherein the hub edge extends substantially to an outer radial limit of the hub wall

11. The compressor wheel of claim 1, wherein the wheel lacks splitter blades.

12. The compressor wheel of claim 1, wherein the hub defines a leading-edge-hub-line that is parallel to the axis of rotation.

13. A turbocharger, comprising:
the compressor wheel of claim 1;
a compressor housing; and
a turbine.

14. The turbocharger of claim 13, wherein the compressor housing lacks a ported shroud.

15. A power system, comprising:
an internal combustion engine; and
the turbocharger of claim 13.

16. A compressor wheel, comprising:
a compressor hub defining a hub wall and an axis of rotation; and
a plurality of compressor main blades connected to the hub wall, each main blade defining a hub edge along which the main blade connects to the hub wall, and each main blade defining a leading edge at an inlet end of the main blade, the leading edge defining an axially most downstream point;
wherein a portion of the main blades that is radially outward of the downstream point extends substantially upstream of a blade entry-plane perpendicular to the axis of rotation and passing through the downstream point.

17. The compressor wheel of claim 16, wherein the portion of the leading edge that is radially outward of the downstream point establishes a positive outer-portion upstream-extension-angle of at least 3 degrees.

18. The compressor wheel of claim 16, wherein the portion of the leading edge that is radially outward of the downstream point establishes a positive outer-portion upstream-extension-angle of between 2 and 20 degrees.

19. The compressor wheel of claim 16, wherein the portion of the main blade radially outward of the downstream point establishes a positive outer-portion upstream-extension-angle.

20. A turbocharger, comprising:
the compressor wheel of claim 16;
a compressor housing; and
a turbine.

21. The turbocharger of claim 20, wherein the compressor housing lacks a ported shroud.

22. The turbocharger of claim 21, wherein the wheel lacks splitter blades.

23. A power system, comprising:
an internal combustion engine; and
the turbocharger of claim 21.
